(19) United States
(12) Patent Application Publication
(10) Pub. No.: US 2009/0243221 A1
(43) Pub. Date: Oct. 1, 2009

(54) LEAF SEAL FOR A TURBOMACHINE

(75) Inventors: Sven Olmes, Villigen (CH); Jonas Hurter, Baden (CH)

Correspondence Address: Volpe and Koenig, P.C.;Dept. Alstom, 30 South 17th Street, United Plaza, Suite 1600, Philadelphia, PA, 19103, US

(73) Assignee: ALSTOM Technology Ltd., Baden (CH)

(21) Appl. No.: 12/412,069

(22) Filed: Mar. 26, 2009

(30) Foreign Application Priority Data
Mar. 28, 2008 (CH) 0045908

(51) Int. Cl. F16J 15/44

(52) U.S. Cl. 277/411

(57) ABSTRACT

A leaf seal is provided for sealing a radial gap between a stator and rotor of a turbo machine. The seal includes a plurality of metallic sealing leaves, arranged in a row and attached to a carrier. The leaves are arranged concentrically around the circumference of the rotor and are arranged inclined at an angle to the radial direction of the rotor and in an opposite direction to the rotation direction and also includes front and rear plates connected to the carrier and extend over a circumference of the seal on both sides of the sealing leaves. A first axial distance is defined between the rear plate and the sealing leaves, and a second axial distance is defined between the front plate and the sealing leaves. An apparatus is also included for actively controlled variation of the first axial distance during operation of the turbomachine.

### FIELD OF INVENTION

Leaf seals, also referred to as sealing leaves, are frequently used in turbomachines for sealing gaps between the rotating shaft and the stator (casing, stator blades), whose radial extent varies during machine operation. Leaf seals allow these gaps to be sealed, because of their flexible sealing elements.

### BACKGROUND

By way of example, leaf seals of this type are known from U.S. Pat. No. 6,343,792. They comprise a plurality of individual metallic leaves, which are arranged in a row and form a ring at a predetermined distance between the sealing leaves; the ring is attached to the stator and is arranged around the rotor of the machine. In this case, the metal leaves are at an angle to the radial direction of the rotor, in which case this angle may either be of equal magnitude or may vary slightly over the length of the leaf, that is to say the leaves are slightly curved. They are highly flexible in the circumferential direction. In contrast, in the axial direction of the machine, that is to say in the direction of the pressure differential, they are highly rigid, which makes it possible to withstand a greater pressure difference while maintaining a radial freedom of movement. Leaf seals of this type are furthermore distinguished in that, in comparison to other flexible seals such as brush seals, they have a low friction resistance. This is a result of a dynamic pressure which is created in the area of the sealing leaves on the shaft during machine operation, allowing the leaf ends to be lifted off by a minimum distance of the order of magnitude of micrometers, thus reducing the friction.

An end plate is frequently arranged in each case on the high-pressure side and on the low-pressure side of the sealing leaves. These are separated axially from the sealing leaves as shown in FIGS. 12 and 13 in U.S. Pat. No. 6,343,792, in such a way as to allow the leaves to move without friction. The radial extent of the end plates is in this case approximately equal to that of the sealing leaves.

Further leaf seals for turbines with end plates of this type are disclosed, for example, in EP 1 231 416. There, the seal has an annular element 50, which maintains the distance between the end plate and the sealing leaves on the low-pressure side of the sealing leaves, and thus predetermines the pressure distribution over the seal.

DE 10 2004 020 378 discloses a leaf seal for a turbine, and in particular a separation between the individual sealing leaves, which allows an air gap and an air flow through the seal which, depending on the extent of the air flow, initiates a so-called blow-down or blow-up effect. In the case of a blow-down effect, the sealing leaves are pressed against the shaft while, in the case of a blow-up effect, they are pressed away from the shaft. The extent of the air flow and the corresponding behavior of the sealing leaves during machine operation can be predetermined by using spacing elements to select the distance between the sealing leaves. Furthermore, the air flow can also be predetermined by a selected and fixed axial distance between the end plates and the sealing leaves on the high-pressure side and on the low-pressure side, as shown in FIG. 3.

Leaf seals of this type are typically produced by mechanical techniques such as firm clamping, welding or brazing, or a combination of these techniques.

EP 1 626 210 discloses a leaf seal of this type with sealing leaves with a T-shaped cross section and with end plates on the high-pressure side and low-pressure side, which are each fixed in a groove on the sealing leaves. The distances between the end plates and the sides of the sealing leaves are thus fixed. The end plate on the low-pressure side is formed with a step, such that the distance between end plate and sealing leaf is greater in an area close to the rotor than in an area further away from the rotor. The distance on the low-pressure side is in each case greater than the distance on the high-pressure side.

WO 2006/016098 discloses a further leaf seal, in which the sealing leaves are radially inclined at their edge on the high-pressure side, and an end plate on the high-pressure side has a projection on its rotor-side edge, which projection extends axially toward the sealing leaves. When the sealing leaves bend, the incline results in the gap between the end plate and the sealing leaves being enlarged, as a result of which the aerodynamic forces change in a corresponding manner. Different embodiments have different, predetermined inclines for specific machines, which point either toward the high-pressure side of the seal or toward the low-pressure side, with the axial projections on the end plate having predetermined shapes which differ for specific machines.

### SUMMARY

The present disclosure is directed to a leaf seal for sealing a radial gap between a stator and rotor of a turbo machine. The seal includes a plurality of metallic sealing leaves, arranged in a row and attached to a carrier. The leaves are arranged concentrically around the circumference of the rotor and are arranged inclined at an angle to the radial direction of the rotor and in an opposite direction to the rotation direction. The seal also includes front and rear plates connected to the carrier and extend over a circumference of the seal on both sides of the sealing leaves. A first axial distance is defined between the rear plate and the sealing leaves, and a second axial distance is defined between the front plate and the sealing leaves. An apparatus is also included for actively controlled variation, during operation of the turbomachine, of the first axial distance between the sealing leaves and the rear plate.

### BRIEF DESCRIPTION OF THE DRAWINGS

FIG. 1 shows a perspective view of a leaf seal arranged between the stator and rotor blade tips of a turbomachine. The figure shows a fundamental basic form of a leaf seal, in which a carrier plate and a front plate and rear plate are arranged in a general form.

FIG. 2 shows a cross section through a seal, based on a section along II-II in FIG. 1. In this case, the carrier plate, front plate and rear plate are arranged according to a first embodiment of the invention.

FIG. 3 shows a detail of the leaf seal, based on the detail III as indicated in FIG. 2, in particular in the area of the sealing leaves and the rear plate.

FIG. 3a shows the seal from FIG. 3 and its installation in the stator of a turbomachine.

FIG. 3b shows a seal according to an embodiment of the invention, with a schematic diagram of a circuit for controlling the seal.

FIG. 4 shows a cross section of a seal, based on a section along II-II in FIG. 1. In this case, the carrier, front plate and rear plate are formed integrally in the form of a bracket.

FIG. 5 shows a cross section of an embodiment of a seal similar to that in FIG. 4, with the sealing leaves additionally having profiled edges.

The same reference symbols in the various figures in each case indicate the same components.

### DETAILED DESCRIPTION OF THE PREFERRED EMBODIMENTS

### Introduction to the Embodiments

The present disclosure is based on the object of providing a leaf seal for sealing the radial gap between the stator and rotor of a turbomachine, which has a longer operating life than leaf seals from the prior art and thus allows more cost-effective sealing.

A leaf seal for a turbomachine in order to seal a radial gap between the stator and rotor of the turbomachine has a plurality of metallic sealing leaves which are arranged in a row and are attached to an annular carrier, and are arranged concentrically over the circumference of a rotor of the turbomachine. The sealing leaves are in this case arranged inclined at an angle to the radial direction of the rotor and in the opposite direction to the rotation direction. Furthermore, the seal has front and rear plates, which are connected to the carrier and extend over the circumference of the seal, and are at an axial distance from the plurality of sealing leaves with respect to the rotor of the turbomachine. The front plate is in this case located on the high-pressure side and the rear plate on the low-pressure side of the sealing leaves. According to the disclosure, the leaf seal has an apparatus for actively controlled variation, during machine operation, of the axial distance between the edges of the sealing leaves and the rear plate on the low-pressure side.

By variation of the distance between the rear plate and the sealing leaves, the seal according to the disclosure allows an optimum setting of the blow-down effect and blow-up effect for each operating state of the machine. For each operating state, both in the transient and steady-state operating states and for the radial gap sizes which occur in this case, this ensures an optimum sealing function in which at the same time, a minimal amount of wear to the sealing leaves, which would be created by the leaves rubbing against the rotor, can be set to a minimal extent. Minimal wear ensures correspondingly optimized life of the seal. The active setting of the distance between the end plates and the sealing leaves results in an optimum compromise between the sealing effect and wear to the sealing leaves for each operating state of the machine. The minimized wear ensures an increased operating life thus reducing the operating costs of the turbomachine, in that the seals, which are produced by complex and costly processes, need be replaced less often.

During transient operating states, for example while the turbomachine is being started up and shut down, the pressure drop across the seal is small in comparison to that during steady-state operation. The sealing leaves are not yet in contact with the rotor. When the pressure in the machine increases, this results in a blow-down effect and in contact with the rotor. The radial gap is in this case closed, although this results in a large amount of friction between the sealing leaves and the rotor. The apparatus for active variation of the distance of the rear plate on the low-pressure side allows deliberate regulation of the contact-pressure force of the sealing leaves against the rotor corresponding to the operating state, in that the blow-down effect is deliberately reduced or a deliberate blow-up effect is created. The closure of the radial gap is thus maintained, but the friction of the leaves on the rotor is minimized.

In a first embodiment of the invention, the seal has an apparatus for variation of the distance between the rear plate and the edges of the sealing leaves on the low-pressure side, with the apparatus being activated by control signals. As a result of this measure, the effect is greatest on the low-pressure side, because variation of the distance on the low-pressure side of the sealing leaves means that only a blow-down behavior of the seal is initiated.

In a further embodiment of the invention, the seal has an apparatus for active variation of the distance between the sealing leaves and the rear plate and, in addition, the distance between the edges of the sealing leaves on the high-pressure side and the front plate. In particular, the distances are varied such that, when one distance is varied, the second distance is varied as a function of the first distance.

In one specific embodiment, the seal and the apparatus for variation of the distances are designed such that the sum of the distance between the sealing leaves and the rear plate and the distance between the sealing leaves and the front plate always remains constant. This is achieved, for example, by a holder in the form of a bracket or a U-shaped holder, which extends over the sealing leaves and is attached to both the front plate and the rear plate. This embodiment has the special technical advantage of a less complex design of the seal. In addition, it makes it possible to move the seal over a very wide operating range.

In all the embodiments, the control range of the active variation of the distance extends from zero to about one third of the axial extent of the sealing leaves. At a distance of about one third or less, the influence on the pressure ratios in the seal ceases. Outside this range, the influence on operation of the machine is too small.

Active variation of the distance to the rear plate or the distances to the two end plates can be achieved, for example, by a pneumatic or electromechanical apparatus.

In order to guarantee that the distance is set as accurately as possible and that the seal operates optimally in terms of life and sealing function, the seal has an apparatus for distance measurement between the end plate and the edges of the sealing leaves, as well as a line for transmission of the distance measured values to a control loop. The control loop is used to compare the distances of the end plate or end plates with predetermined target values for the distance, and if necessary to adapt them.

These target values are preset for example between the housing and the rotor or between the housing and the rotating blade tips, depending on the type of seal fitted.

In a further embodiment, the edges of the sealing leaves are profiled, such that the sealing leaves are narrower in an area closer to the rotor than in an area which is further away from the rotor and is closer to the carrier. This guarantees a minimum distance between the sealing leaves and the end plates, and reduces the risk of lateral friction, or even of mechanical jamming.

In a further embodiment, the seal is arranged between a stator of the turbomachine and the rotating blade tips of the rotor. The gap between the stator and the blade tips has a pronounced large radial clearance such that, when using a conventional leaf seal, either the gap is not always closed or particularly rapid wear occurs. The arrangement of the seal results in the particular advantage that this gap is also closed with a large radial clearance in all operating states, with the wear being minimized and the operating life being correspondingly increased, in turn. The radial extent of the front plate and rear plate should not be greater than a given maximum size, bearing in mind the relatively large range of the radial clearance between the blade tips and the stator, thus ensuring a clearance between the front plate and rear plate and the blade tips, and thus the full radial freedom of movement, in all operating states, in order to prevent rubbing of the plates. On the other hand, the minimum radial size of the end plates must be designed so as to ensure coverage of the area which leads to gaps between the sealing leaves when the sealing leaves are making contact. As already mentioned, this may be about one third of the axial extent of the sealing leaves.

### DETAILED DESCRIPTION

The following exemplary embodiments can be used in various turbomachines, such as gas turbines, compressors, steam turbines.

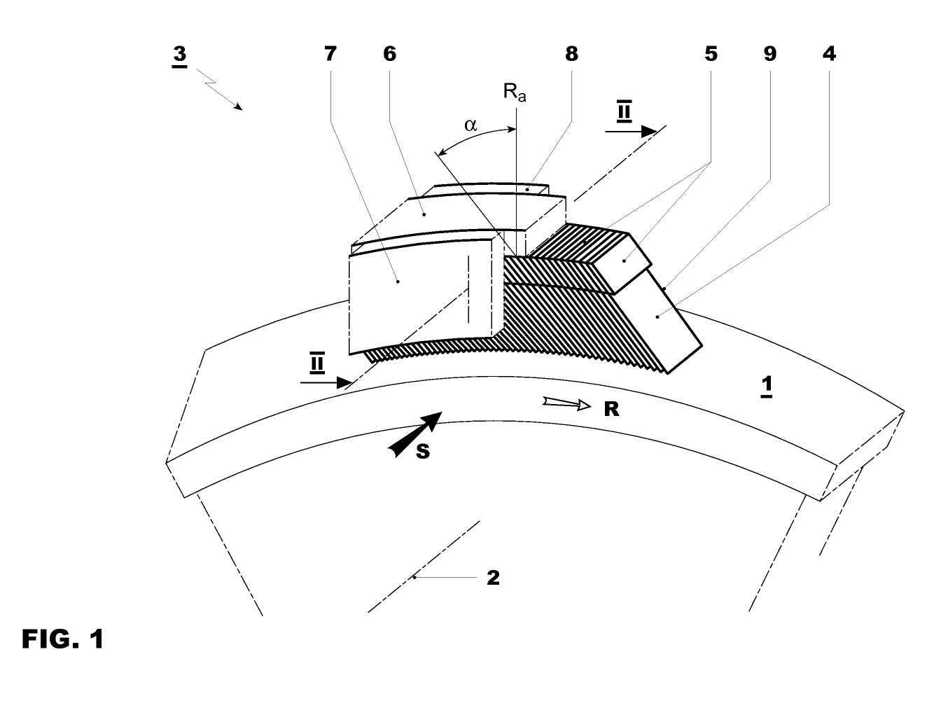

FIG. 1 shows a rotor 1 of a turbomachine, for example a gas turbine or compressor, with the rotor 1 rotating in the direction R around a rotor axis 2. A stator, which is not illustrated, surrounds the rotor of the machine, with a seal 3 being attached to the stator, the seal 3 can close a radial gap between the stator and the rotor 1. The gap has an extent in the radial direction Ra which can vary during transient operation of the machine, in particular during starting up and shutting down, and during load changes. The sealing of the gap between the stator and the rotor prevents leakage of the flow of a working fluid, which is flowing in the direction of the arrow annotated S. The seal 3 is a leaf seal and has a plurality of sealing leaves 4, which are arranged inclined at an angle α to the radial direction Ra and in the opposite direction to the rotation direction R of the rotor. A spacing element 5 is arranged between each of the individual sealing leaves 4. The sealing leaves 4 are attached at a carrier 6 on the stator, for example by welding. The carrier 6 and the row of sealing leaves 4 attached to it extend in an annular shape and concentrically over the circumference of the rotor 1. Furthermore, on the carrier 6, a front plate 7 is arranged on the high-pressure side of the seal 3, and a rear plate 8 is arranged on the low-pressure side of the seal 3.

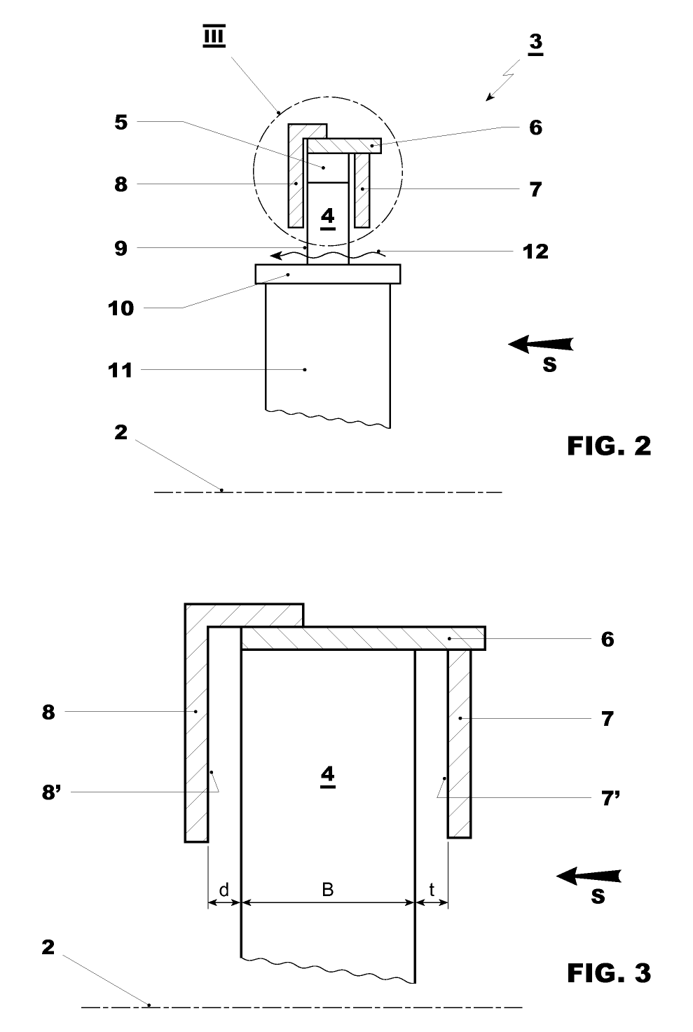

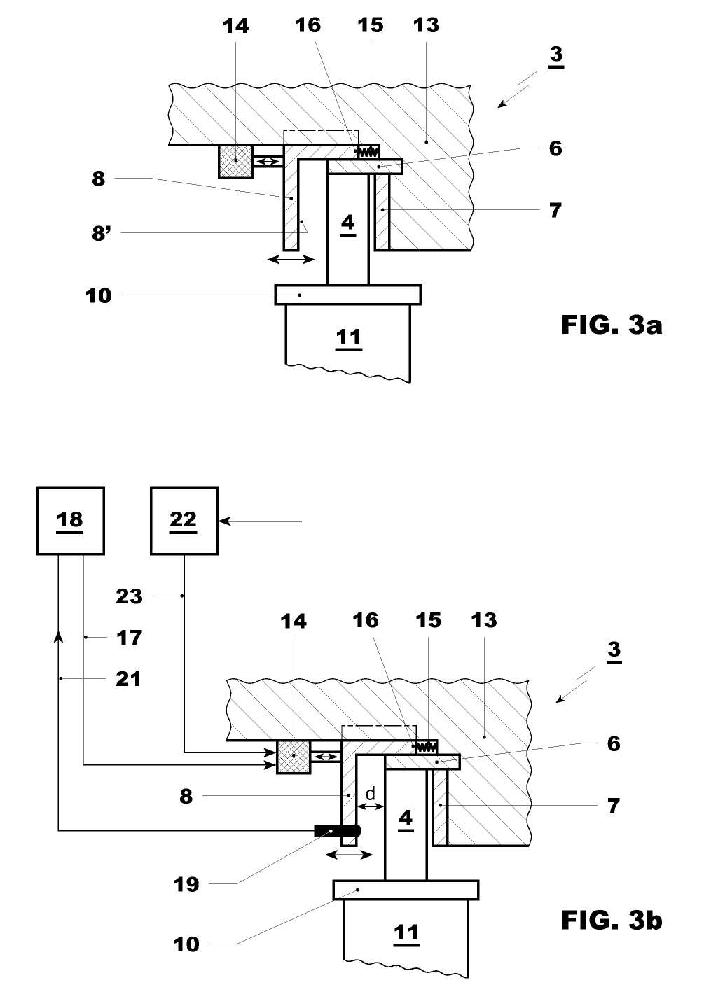

The seal 3 can be arranged either between a stator and a shaft or between a stator and the tips of rotor blades. A blow-up effect or blow-down effect results on the sealing leaves 4, depending on the pressure ratios, on the basis of which the sealing leaves are pressed away from the rotor 1 or are pressed toward the rotor 1. In the case of a strong blow-down effect, the contact-pressure force of the sealing leaves 4 on the rotor surface is increased, and thus the sealing effect, as a result of which the gap is closed, although the friction and the wear of the sealing leaves are also increased at the same time. In the case of a blow-up effect, on the other hand, the contact-pressure force and the sealing effect are reduced, with the friction likewise being reduced. According to the disclosure, the seal has an apparatus for actively controlled variation of the axial gap between the rear plate 8 and the edge 9 of the sealing leaves 4 on the low-pressure side in order to control the blow-up effect or blow-down effect, as shown in FIGS. 2, 3, 3a and 3b.

FIGS. 2 and 3 show a seal according to the disclosure with one of the sealing leaves 4 and the front plate 7 on the high-pressure side, the rear plate 8 on the low-pressure side and the carrier ring 6. The illustrated seal 3 is arranged between a stator, which is not illustrated, and the blade tip 10 of a turbine rotor blade 11 or compressor blade. A leakage flow, which occurs between the stator and the rotor if the gap is not closed completely, is indicated by the arrow 12. There is a gap or first axial distance of width d between the rear plate 8 on the low-pressure side, in particular the inner edge 8′, and the edge 9 of the sealing leaves 4, the gap can be varied according to the operating state of the turbine. There is a second axial distance of width t between the edge of the sealing leaves 4 on the high-pressure side and the front plate 7. FIG. 3a shows the seal from FIG. 3, in which, for example, the carrier 6 and the front plate 7 are in the form of an integral part of the stator 13. The gap between edge 8′ of the rear plate and the sealing leaf 4 is varied, for example, by a pneumatic or electromechanical apparatus 14. In this case, a minimum width of the gap between the axial end 16 of the rear plate 8 and the stator 13 can be ensured by a spring 15.

In one embodiment, the apparatus 14 is designed such that the gap width d can be varied from zero up to a third of the axial extent or of the width B of the sealing leaves during machine operation. The front plate 7 is attached to the high-pressure side of the sealing leaves 4, with there being a gap of width t between the inner wall 7′ of the front plate 7 and the edges of the sealing leaves 4. In one embodiment of the seal, this width is fixed. In this case, the width d of the gap on the rear plate is always less than the gap width t.

According to a further embodiment of the seal 3, as is shown in FIG. 3b, a sensor 19 for measurement of the gap width d is integrated in the rear plate 8. A signal line 21 leads from this to a control unit 18 which has a controller for comparison of the measured gap width d with a predetermined target value for the gap width, and for generation of a control signal for adaptation of the gap width d. The control signals from the unit 18 are transmitted by the signal line 17 to the apparatus 14 for movement of the rear plate relative to the sealing leaves. The sensor 19 for distance measurement of the gap width d is also used to prevent the gap being reduced to zero and to minimize friction of the sealing leaf edge on the end plate. Furthermore, signals can be sent via the signal line 23 to the movement apparatus 14 from the turbomachine, for example a trip signal from the unit 22. A trip signal such as this can initiate a movement of the rear plate 8 to a position with a maximum distance d.

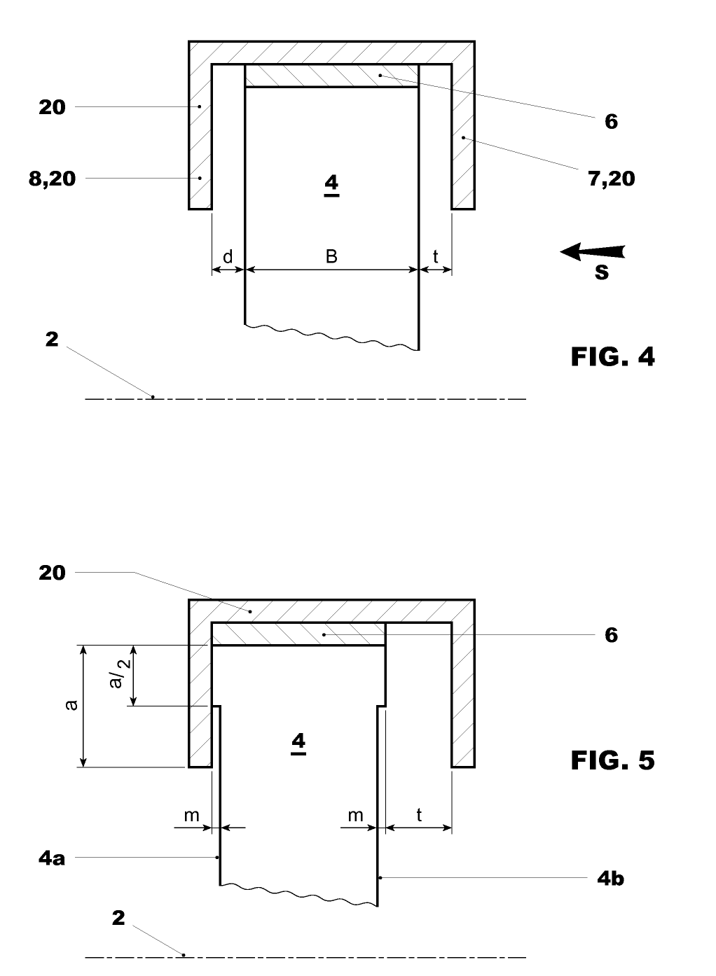

FIG. 4 shows a further embodiment of the rear plate and front plate in an embodiment of an integral part 20, which allows simultaneous movement of the front plate and rear plate, in which case the sum of the gap between the sealing leaves and the rear plate and the gap between the sealing leaves and the front plate always remains constant. For this purpose, the end plates are manufactured as an integral part 20 with a cross section in the form of a bracket, or with a U-shaped cross section. An axial movement of the part 20 relative to the sealing leaves 4 is provided either by attaching the sealing leaves to the stator and an apparatus for movement of the part 20. For this purpose, for example, the sealing leaves together with their carrier 6 can be connected to the stator by a plurality of bushings, which lead through openings through the part 20.

Alternatively, the axial movement of the part 20 relative to the sealing leaves 4 can be provided by a fixed attachment of the part 20 to the stator, with the sealing leaves 4 and the carrier 6 being moved axially by bushings and corresponding guide openings in the part 20.

The simultaneous variation makes it possible to completely exploit the blow-up and blow-down potential of the seal. Furthermore, intermediate states can be set in a continuously variable manner, and the force can be deliberately applied to the metal leaves. When the turbine is in special operating states, for example a trip, the seal could be brought immediately to the maximum blow-up response, preventing rubbing, since in this case it is possible for states to occur which lead to maximum radial movement into the seal. In a further operating state, a so-called “hot restart”, a maximum amount of radial movement is demanded, which the seal withstands best when it is operated in a blow-up configuration.

A further embodiment of the seal 3, as shown in FIG. 5, essentially has the same seal design as that in FIG. 4 with regard to the arrangement of the rear plate and front plate. In addition, in this case, the sealing leaves 4 have a profile on the respective edges 4a and 4b on the low-pressure side and high-pressure side of the sealing leaves 4. In particular, the profile is designed such that only a portion of the edge of the sealing leaves can come into contact with the end plate in the area of the end plates, and a small gap with width m is guaranteed over the rest of the edge. By way of example, the reduction in the width of the sealing leaf 4 extends over a region (a/2) or half the region (a) of the sealing leaves which is covered by the end plates. The minimum step along the edges 4a and 4b has a width m of, for example, 0.2 mm or an extent which would avoid friction of the sealing leaves on the end plate. The maximum gap width t is, for example, 2 mm, or about one third of the width or of the axial extent B of the sealing leaves.

### LIST OF REFERENCE SYMBOLS

1 Rotor
2 Rotor axis
3 Seal
4 Sealing leaves
4a, 4b Lateral profile of the sealing leaves
5 Spacing elements
6 Carrier
7 Front plate
7′ Inner surface of the front plate
8 Rear plate
8′ Inner surface of the rear plate
9 Edge of the sealing leaf
10 Blade tip
11 Blade
12 Leakage flow
13 Stator
14 Movement apparatus
15 Spring
16 End of the rear plate element 8
17 Signal line
18 Control unit
19 Sensor
20 Integral part for the front plate and rear plate
21 Signal line
22 Control unit
23 Signal line
R Rotation direction of the rotor
Ra Radial direction with respect to the rotor axis
S Flow direction of the working fluid
α Angle of the sealing leaves with respect to the radial direction Ra
t, d Gap width between the sealing leaves and the front plate and rear plate, respectively
B Width of the sealing leaves
m Width of the step on the profile of the sealing leaves
a Length of the end plates over the sealing leaves

What is claimed is:

1. A leaf seal (3), for sealing a radial gap between a stator and rotor (1) of a turbomachine, comprising: a plurality of metallic sealing leaves (4), arranged in a row and attached to a carrier (6), the leaves (4) being arranged concentrically around a circumference of the rotor (1) and are arranged inclined at an angle (α) to a radial direction (Ra) of the rotor (1) and in an opposite direction to a rotation direction (R); front and rear plates (7, 8) connected to the carrier (6) and extending over a circumference of the seal (3) on both sides of the sealing leaves (4), a first axial distance (d) is defined between the rear plate (8) and the sealing leaves (4), and a second axial distance (t) is defined between the front plate (7) and the sealing leaves (4); and an apparatus for actively controlled variation of the first axial distance (d) during operation of the turbomachine.

2. The seal (3) as claimed in claim 1, wherein the seal (3) comprises an apparatus for controlled variation of the axial distances (d, t) between both the front plate (7) and the sealing leaves (4) and the rear plate (8) and the sealing leaves (4) in a mutually dependent movement.

3. The seal (3) as claimed in claim 2, wherein a sum of the first axial distance (d) and the second axial distance (t) is always constant.

4. The seal (3) as claimed in claim 1, wherein the apparatus for controlled variation of the axial distances (d, t) is pneumatic or electromechanical apparatus.

5. The seal (3) as claimed in claim 3, wherein the front plate (7) and the rear plate (8) are attached to or are integral with a holder (20) extending over the carrier (6) of the sealing leaves (4).

6. The seal (3) as claimed in claim 1, wherein a control range of the controlled variation of the distance (d) between the rear plate (8) and the sealing leaves (4) extends from zero to about one third of an axial extent (B) of the sealing leaves (4).

7. The seal (3) as claimed in claim 1, further comprising a sensor (19) for measurement of the distance (d) between the rear plate (8) and the sealing leaves (4), and a line (21) for transmission of distance measured values to a control unit (18) for adaptation of the distance (d) between the rear plate (8) and the sealing leaves (4).

8. The seal (3) as claimed in claim 1, wherein the leaves (4) comprise edges (4a, 4b) having a profile with a step in an area of the rear plate (7) and front plate (8).

9. The seal (3) as claimed in claim 1, wherein the seal (3) is arranged between the stator and rotating blade tips (10) of the turbomachine.
